(19) United States
(12) Patent Application Publication
(10) Pub. No.: US 2026/0187127 A1
(43) Pub. Date: Jul. 2, 2026

(54) SCORING LONG INPUTS FOR LARGE MULTIMODAL MODELS

(71) Applicant: NVIDIA Corporation, Santa Clara, CA (US)

(72) Inventors: De-An Huang, Cupertino, CA (US); Subhashree Radhakrishnan, Milpitas, CA (US); Zhiding Yu, Cupertino, CA (US); Jan Kautz, Lexington, MA (US)

(21) Appl. No.: 19/274,194

(22) Filed: Jul. 18, 2025

Related U.S. Application Data
(60) Provisional application No. 63/740,715, filed on Dec. 31, 2024.

(51) Int. Cl. G06F 16/335; G06F 16/535; G06F 16/735

(52) U.S. Cl. CPC G06F 16/335; G06F 16/535; G06F 16/735

(57) ABSTRACT

Generating a response to a query from a long input can be difficult because of the number of data units to be analyzed, where a data unit can be a video frame, an image, a page, a slide, a word count, or other data unit. The FRAG process can first reduce the number of data units to be analyzed, such as using down-sampling, temporal proximity, visual similarity, or other algorithms. The reduced number of data units can be further reduced by scoring each data unit and selecting the data units that have the highest likelihood of addressing the query, such as using a Top-K or scoring threshold parameter. The data units that satisfy the scoring algorithm can be processed by an LMM to generate a response to the query. The focusing of the data units for the LMM can improve the quality of the response that the LMM generates.

### CROSS-REFERENCE

This application claims the benefit of U.S. Provisional Application Ser. No. 63/740,715, filed by De-An Huang, et al., on Dec. 31, 2024, entitled “FRAME SELECTION AUGMENTED GENERATION FOR LONG VIDEO AND LONG DOCUMENT UNDERSTANDING,” commonly assigned with this application and incorporated herein by reference in its entirety.

### TECHNICAL FIELD

This application is directed, in general, to machine learning language models and, more specifically, to language modelling using long inputs, such as long video and multi-page documents as inputs.

### BACKGROUND

Language models (LMs) are a type of machine learning (ML) models that are trained on text data to generate words based on context of given text. LMs are used for various functions, such as auto-suggestions when typing, content generation, document summarization, and conversational artificial intelligence (AI). Large language models (LLMs) are a type of language models that have been trained on massive amounts of text data and use deep learning to identify complex data patterns. As suggested by the name, small language models (SLMs) are smaller in scale than LLMs and are often trained on specific datasets.

Multi-modal language models (MLMs) are ML models that are capable of processing different types of data to generate outputs. For example, MLMs can generate outputs by processing different modalities of data, such as images, audio, and text. As such, MLMs can be trained using different modes of data. Large Multimodal Models (LMMs) have demonstrated impressive multimodal understanding capabilities, such as captioning and visual question answering on images and videos. Recent works further extend LMMs to long input data, such as multi-page documents and long videos. Training these long context LMMs, however, poses challenges to data and computation.

### SUMMARY

In one aspect, a query system is disclosed. In one embodiment, the query system includes (1) a long input scorer configured to score scoring data units of a long input, wherein the scoring data units are frames when the long input is a video or a series of images, or the scoring data units are pages when the long input is a document, and (2) a large multimodal model (LMM) configured to select a set of data units from the scoring data units where each data unit in the set of data units satisfies a score threshold parameter, and to process the set of data units, using a received query, to generate a result to the received query.

In a second aspect, a method is disclosed. In one embodiment, the method includes (1) receiving input parameters, a query, and at least one long input, wherein the query is to be associated with the at least one long input, (2) determining a set of scoring data units, wherein the set of scoring units is selected from original data units of the at least one long input, (3) scoring each data unit in the set of scoring data units using the input parameters, (4) selecting a second set of data units from the set of scoring data units that satisfy a scoring threshold parameter using the input parameters and the query, (5) processing the second set of data units and the query using a large multimodal model (LMM), and (6) generating a result to the query using an output of the LMM.

In a third aspect, a system is disclosed. In one embodiment, the system includes (1) a receiver system configured to receive a query, a long form input, and input parameters, (2) a scoring system configured to determine a set of data units to score from data units included with the long form input, to score the set of data units, and to select a second set of data units from the set of data units when a respective score of each data unit satisfies a score threshold parameter, and (3) one or more processors, configured to execute code representing a large multimodal model (LMM) and to process the second set of data units and the query to generate an output.

In a fourth aspect, a non-transitory computer program product having a series of operating instructions stored on a non-transitory computer-readable medium that directs a data processing apparatus when executed thereby to perform operations is disclosed. In one embodiment, the operations include (1) receiving input parameters, a query, and at least one long input, wherein the query is to be associated with the at least one long input, (2) determining a set of scoring data units, wherein the set of scoring units is selected from original data units of the at least one long input, (3) scoring each data unit in the set of scoring data units using the input parameters, (4) selecting a second set of data units from the set of scoring data units that satisfy a scoring threshold parameter using the input parameters and the query, (5) processing the second set of data units and the query using a large multimodal model (LMM), and (6) generating a result to the query using the output of the LMM.

### BRIEF DESCRIPTION

Reference is now made to the following descriptions taken in conjunction with the accompanying drawings, in which:

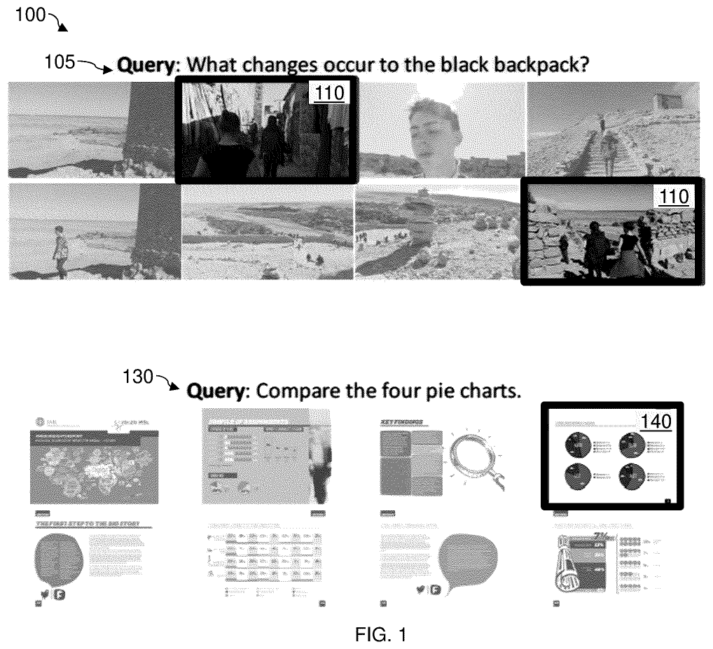

FIG. 1 is an illustration of diagrams of example data unit scoring;

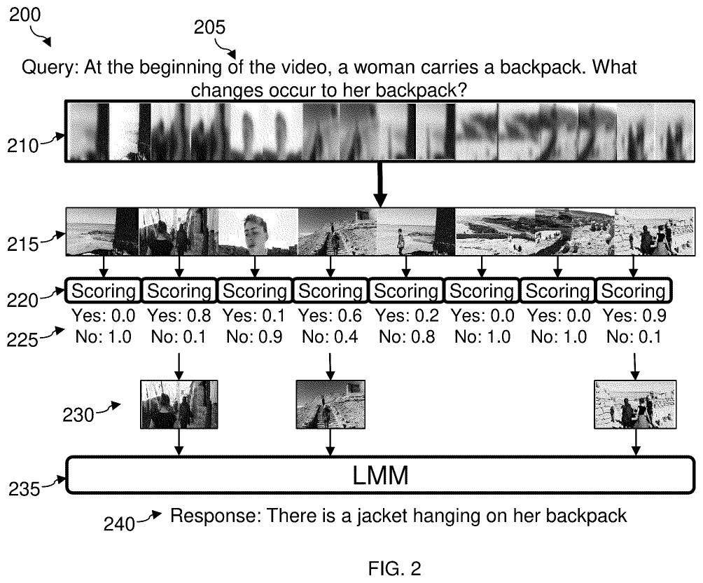

FIG. 2 is an illustration of a diagram of an example overview of the FRAG process;

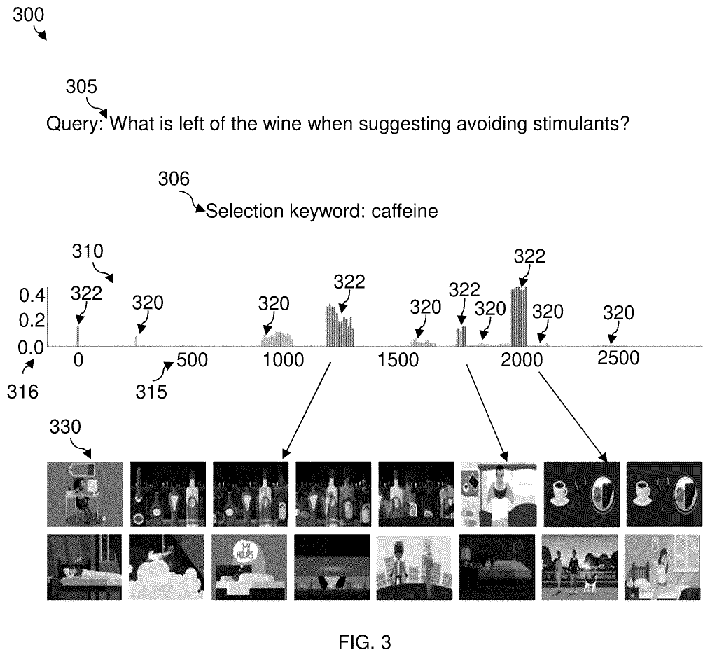

FIG. 3 is an illustration of a diagram of an example comparison of the FRAG process and a uniform selection process;

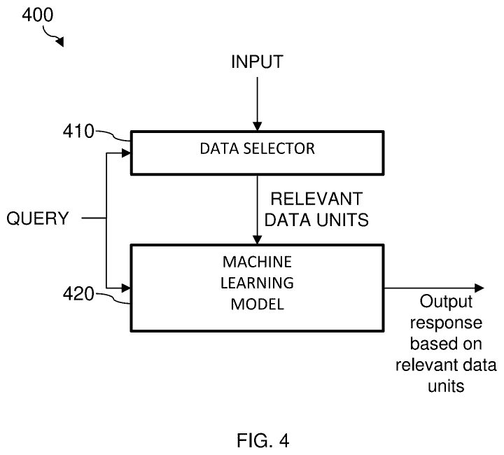

FIG. 4 is an illustration of a block diagram of an example query system 400 using the FRAG process;

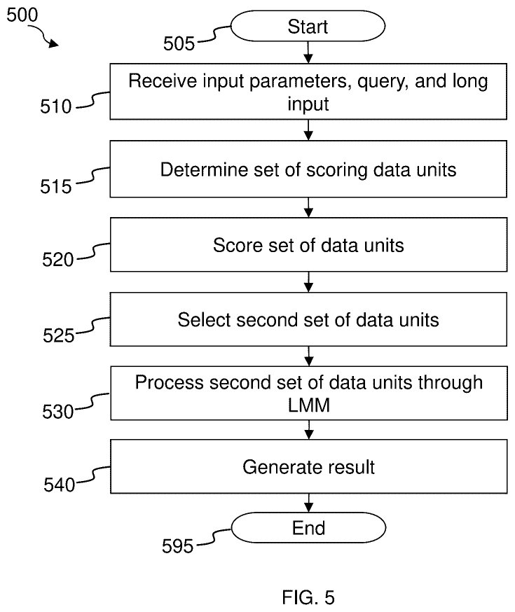

FIG. 5 is an illustration of a flow diagram of an example method to implement a hybrid-head architecture model;

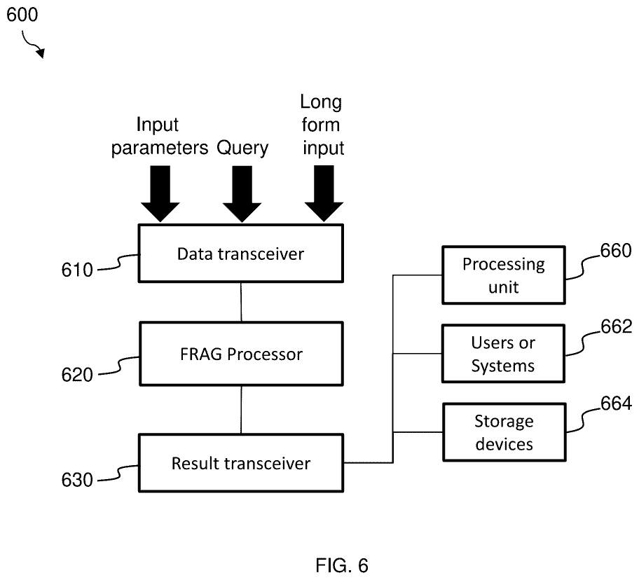

FIG. 6 is an illustration of a block diagram of an example FRAG system; and

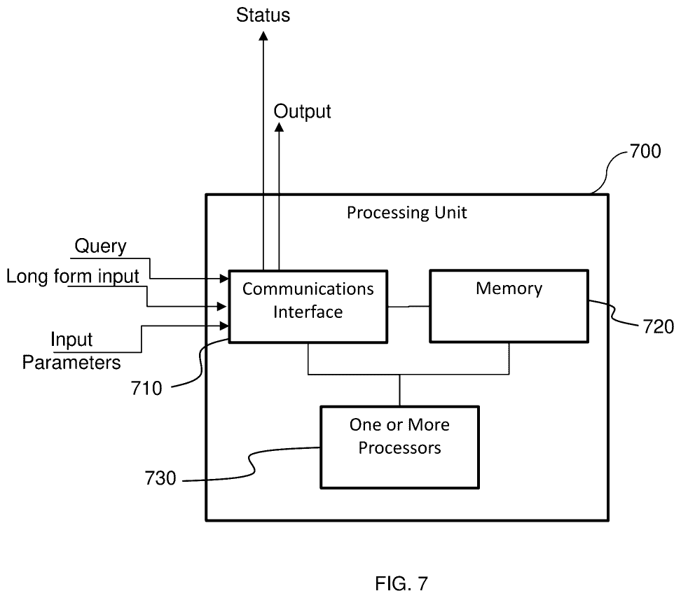

FIG. 7 is an illustration of a block diagram of an example of a FRAG controller according to the principles of the disclosure.

### DETAILED DESCRIPTION

Language models (LM) are being used to process input text and output context-aware responses to the input text. Large language models (LLMs) process a significant amount of data to generate large models. The cost in memory and storage of the key-value (KV) tokens makes LLM accessibility under some hardware configurations difficult, such as small form factor computing systems (for example, a smartphone). Small language models (SLMs) show promise to fill in the gap left by the LLMS. Current SLMs have architectures that may not be efficient in some scenarios. State space models (SSMs) can offer constant complexity and efficient hardware optimization. Though they can struggle with memory recall tasks, thereby affecting their performance. Hybrid language models (HLMs) have been introduced to try to reduce the efficiency gaps of the existing LMs.

Large Multimodal Models (LMMs) have demonstrated impressive multimodal understanding capabilities, such as captioning and visual question answering on images and videos for various types of language models. Recent works further extend LMMs to long input data, such as multi-page documents and long videos. Training these long context LMMs, however, poses challenges to data and computation. First, high-quality long context data is more costly to obtain than typical multimodal data. Recent works thus aim to train long context LMMs without or with limited long context multimodal data. Second, long context LMMs have higher computational costs. Even with sequence parallelism methods to avoid memory limitations of a single device, the computation requirement can be higher than the typical training of LMMs. Therefore, existing long context LMMs are limited in model sizes, often in the 7 billion (B) parameter range. This is in contrast to typical LMMs, which can be scaled to over 70 B parameters. These challenges limit the capabilities of existing long-context LMMs.

To narrow the scope of the work, the following question can be asked: “Do we need long context LMMs for long input data?” For example, to respond to a question about a black backpack in a long video, the first step can be to fast-forward through the video and find the relevant moments to respond to the question (i.e., frames with the black backpack). Similarly, for long documents, to respond to a question about pie charts, the process can first skim through the pages and focus on the pages with pie charts. In these examples, the whole long input is not processed at once. Instead, a decision is made for each frame or page independently. To determine whether a frame or page is relevant to the question, relevant information can be checked if present in the frame or page. This initial action does not need global long context processing.

This disclosure presents processes labeled as frame selection augmented generation (FRAG) for a long form input, such as a video, a series of images, or a document, to understand and respond to a query. The long form video can be, for example, a surveillance video, a streaming video, or other video types. The long form document can be, for example, a slide deck, a presentation, a PDF document, or other document type.

Given a long input and a query, FRAG can first score each frame or page (e.g., a data unit of the long input) independently for its relevance to the query, where the frame or page is used as the data unit as appropriate for the long input. In some aspects, a page can be defined as a specified number of words, for example, 250 or 300 words. This aspect can be used when a long document does not contain page breaks or page indicators. In some aspects, the long input can be more than one video, more than one set of images, more than one document, or a combination thereof.

In some aspects, the scoring can be done by a long input scorer. The frames or pages with the highest scores can then be selected and fed into an LMM to generate the final outputs (e.g., results). In some aspects, the result can be text-based, such as a description or paragraph. In some aspects, the result can be an image or a series of images. In some aspects, the result can be a video. Since the frames or pages can be scored independently, FRAG does not require long-context LMMs to process the whole input. The highest scores can be determined as a score that satisfies a score threshold parameter.

Frames and pages can be scored and thus selected in FRAG using different algorithms. Existing LMMs or long input scorers can perform zero-shot scoring (e.g., zero-shot processing)without further tuning. For each frame, a question can be asked of the LMM such that: does the image contain sufficient information to respond to the query? (This query is for demonstration purposes. The actual query would be specific to the model programming language being used and the software implementation being used.) In some aspects, this question can be incorporated into a sufficiency threshold. The probability that the LMM can respond in the positive to this query can be effective for selecting the relevant frames, e.g., satisfying the sufficiency threshold parameter or satisfying a probability specified by the sufficiency threshold parameter for a certain type of response. This type of query, structured appropriately for each type of LMM, can be applicable to a wide range of LMMs.

This leads to an effective inference procedure for FRAG. Given an LMM, FRAG can respond to a query about long inputs by: (1) scoring each frame in the input independently by asking the LMM whether the frame contains sufficient information to respond to the query, (2) selecting the Top-K frames by the probability that the LMM responds in the positive, where the probability can be specified as a score threshold parameter, and (3) feed the selected frames back to the LMM to generate the final response (e.g., result).

FRAG can address issues of existing methods for long context LMMs. First, FRAG can be a zero-shot process and does not need long context training data. Second, FRAG can apply to various model sizes and is not limited to the smaller model sizes because of computational limitations. Computationally, FRAG can be more affordable and flexible than processing the same amount of frames jointly by a conventional long context LMM because the quadratic self-attention never processes the frames simultaneously in the disclosed processes. FRAG's scoring process can be computed in parallel or at least partially in parallel across different processing systems, as each frame can be scored independently. The processing systems can be cores of one processor, multiple processors, or multiple machines, such as FRAG system 600 of FIG. 6 or FRAG controller 700 of FIG. 7.

In testing the disclosed processes, FRAG can improve the performance for long video and long document understanding for two LMM families and five model sizes. FRAG can unify long video and long document understanding. For videos, in demonstrating testing FRAG can improve the test parameters by 3.7% to 5.8%, other improvement values, higher or lower, can be observed with different long inputs and different LMMs. In some testing, FRAG can outperform GPT-4o. For documents, FRAG can outperform specialist models that may need training and OCR modules, for example, doubling the F1 score compared to conventional solutions. FRAG can outperform recent LMMs specialized in long document understanding, in some example testing, by over 20%.

Given a long video or long document, the first step of FRAG can be to score selection proposals (e.g., data units). This consists of two steps: proposal generation and proposal scoring. In some aspects, for proposal generation, uniform down-sampling can be performed on the original data units, for example, a number of frames (e.g., 2664, or other values, whether higher or lower) to generate the scoring data units. In some aspects, proposal generation can utilize computational costs in selecting data units.

In some aspects, each of the sampled frames can be treated as a proposal. In some aspects, multiple frames can be included in each proposal. For this disclosure, the explanations use a single-frame proposal method. Given a fixed number of frames K to select, the single frame proposal can ensure that each of the selected frames is selected because of its high relevance to the query. In contrast, if proposals are generated by segments (e.g., multiple consecutive frames), then there might be redundant information in the selected segments due to temporal proximity, which may not make the best use of the budget K.

Given a query, an LMM can be used to score each proposal. LMMs can give high-quality scores with no training, where high-quality is measured as accurately scoring relevant frames or pages as satisfying the score threshold parameter. High-quality measurements can be determined using a satisfaction of a quality threshold parameter. In some aspects, scoring can be a binary choice problem, e.g. a binary scoring algorithm, which many LMMs are trained on. The following Prompt 1 can capture the main idea.
Prompt 1: Example Pseudo-prompt to demonstrate a frame or page query
Question: <input query>
Does the image contain sufficient
information to respond to the given question?
A. yes, B. no
Response with the option's letter.

LMMs can follow the instructions and respond to the prompt. The probability that the LMM responds in the positive for a frame or page as its score. For a video frame, the score can be lower than 0.5 because it is less likely for a single frame to contain sufficient information to respond to a question about the whole video. Nevertheless, the score can still be indicative of the frame's relevance to the query.

The next step can be to select proposals based on their scores. A selection of the Top-K scoring proposals can be made, where satisfying a score threshold parameter indicates a proposal to be selected. In some aspects, the score threshold parameter can indicate a temporal proximity, and the data units are selected using this proximity. For example, data units can be selected if they share a temporal time frame or the additional data units can be unselected if the information repeats information already captured by a data unit. In some aspects, the score threshold parameter can indicate a visual similarity, which can be used to select the data units. For example, visually similar frames or images can be used if they help to respond to the query, or the additional frames or images can be unselected if they repeat information already represented by a selected data unit. The selected frames can be sorted by their temporal proximity or visual similarity for videos and images, and by page order for documents. The selected frames can be fed into the responding LMM to generate the outputs. The multi-image multimodal prompting format for each LMM can be used to input the selected frames. Each frame in a video can be formatted as an image while not using special formats for video frames. This allows the use of multi-image LLMs while not being limited to LMMs trained on videos.

In some aspects, a Top-K selection works well for videos and documents for this disclosure. For videos, although the scoring might not be perfect, selecting the Top-K gives room for errors. The LMM can still ignore the irrelevant information and respond to the question. Similarly, for documents, although most of the information needed to respond to a question can be contained in a single page, more than one page can be selected. Even if the scoring LMM does not give the highest score to the best page, it can be more likely that the highest scoring page is in Top-K. While there are more complex approaches to select the frames based on the scores (e.g., by considering the temporal diversity or proximity), LMMs can zero-shot process frame selection for long videos and long documents. Top-K selection can be a direct way to demonstrate this.

FRAG does not depend on a specific LMM. In some aspects, for videos, a uniform sample of 2664 frames can be taken prior to the Top-K selection. In some aspects, using a Top-K algorithm, the Top-32 or Top-24 frames can be selected from this uniform sample. In other implementations, other Top-K values (e.g., Top-K parameters) can be used. In other implementations, other uniform sampling values can be used. By using the FRAG process, the results are an improvement over a uniform sampling algorithm. In some aspects, a Top-K of 2 can be used for long documents, meaning the top two pages are selected.

Turning now to the figures, FIG. 1 is an illustration of diagrams of example data unit scoring100. Data unit scoring 100 demonstrates two queries and two long inputs. Query 105 is followed by a video input. Scoring can be a probability that the video frame could impact the response generation to the query, e.g., the frames with backpacks in them. Frames 110 are the frames that satisfy the scoring threshold parameter and are selected. To respond to a query about the black backpack in the long video, the first step is to fast-forward through the video and find the relevant moments to answer the question, e.g., frames with the black backpack.

Query 130 is followed by slides in a presentation. Scoring can be a binary selection, e.g., focusing on the slides that contain one or more pie charts, such as slide 140. For long documents, to respond to a query about pie charts in the slides, the process can skim through the pages and focus on the pages with pie charts. In these examples, the whole long input does not need to be processed. Instead, a decision can be made for each frame or page independently. To determine whether a frame or page is relevant to the query, a check can be made to see whether relevant information is presented in the frame or page, which does not require global long context processing.

FIG. 2 is an illustration of a diagram of an example overview 200 of the FRAG process. The FRAG process first uses a scoring LMM to score each sampled frame in a video or document. The Top-K scoring frames are then selected to use as input to the responding LMM for answer generation. In aspects, the scoring LMM and the responding LMM can be the same. In some aspects, the scoring LMM and the responding LMM can be different LMMs or different types of LMMs. In some aspects, existing LMMs can serve both purposes without tuning.

Overview 200 shows a query 205 asking about a woman's backpack. A long video 210 is received. Long video 210 can be down-sampled to a set of data units 215, e.g., selected frames of the video. A scoring system 220, e.g., a scoring LMM, can be used to score each data unit in the set of data units. Scoring system 220 can be performed by one or more processors, in serial, in parallel, partially in parallel, overlapping, or other processing sequences. The data units can be scored in various orders or sequences. A scoring result 225 can be generated for each data unit in the set of data units. A scoring algorithm can be applied to select a second set of data units 230, such as satisfying a scoring threshold algorithm. In this example, a scoring threshold of 0.5 or greater is used.

Second set of data units 230 is processed by a LMM 235 to generate an output using the data units and query. LMM 235 can be the same LMM or system as scoring system 220. Result 240 is the response from LMM 235 for query 205. One or more of the down-sampling algorithms, scoring system 220, or LMM 235 can be part of a machine learning system.

FIG. 3 is an illustration of a diagram of an example comparison 300 of the FRAG process and a uniform selection process. Comparison 300 has a query 305 asking about wine and stimulants. From query 305, the keyword ‘caffeine’ can be extracted and used as the basis for selecting data units from the long input. Using long input 330, the scoring system compares uniform frame selection to the FRAG frame selection process in a chart 310. Chart 310 has an x-axis 315 that is a relative frame index of the long input and a y-axis 316 that is an approximate relevance score represented as a probability. Markers 320 on chart 310 show the relevance scores when a uniform frame distribution is selected for the set of data units to be scored. Markers 322 on chart 310 show the relevance scores when the FRAG process is applied to select the data units to be scored. Chart 310 demonstrates that the FRAG process consistently selects data units with a higher relevance score than using a uniform distribution selection algorithm. The uniform sampling can miss important frames and therefore has a lower quality response to the query.

FIG. 4 is an illustration of a block diagram of an example query system 400 using the FRAG process. Query system 400 has a data selector 410 that can select one or more data units from the input. Data selector 410 can implement one or more algorithms to select the data units, such as down-sampling, temporal proximity, visual similarity, probability scoring, binary scoring, and other algorithms. The input can be a long input, such as multiple images, a video, or a document, such as a slide deck, a PDF document, or a text-based document. The input can be a collection of long inputs, such as multiple long inputs and multiple different types (modes) of long inputs. For example, the collection of long inputs can include one or more long videos and one or more long documents.

Data selector's 410 selection process can be performed by independently scoring data units of the long input, which does not require long context processing. In some aspects, a long input scorer can be configured to score scoring data units of the long input. In some aspects, the scoring data units are frames when the long input is a video or a series of images, or the scoring data units are pages when the long input is a document. The data units with the highest scores can be selected by a Top-k selection process or other algorithms. The disclosed framework can be applicable to various types of long inputs using existing LMMs without fine-tuning.

A machine learning model 420 can use the output of data selector 410, e.g., relevant data units, to generate the output, e.g., the result response to the query. Data selector 410 can select one or more data units of the input that is relevant to the query. Data selector 410 and machine learning model 420 can be a multi-modal model (MM), which can be an LMM. Data selector 410 and machine learning model 420 can be the same MM or the same LMM.

FIG. 5 is an illustration of a flow diagram of an example method 500 to implement a hybrid-head architecture model. Method 500 can be performed on a computing system, for example, FRAG system 600 of FIG. 6 or FRAG controller 700 of FIG. 7. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 500 can be encapsulated in software code or hardware, for example, an application, code library, code module, dynamic link library, module, function, RAM, ROM module, and other software and hardware implementations. The software can be stored in a file, database, or other computing system storage mechanism. Method 500 can be partially implemented in software and partially in hardware. Method 500 can perform the steps for the described processes, for example, determining the data units to score, scoring the selected data units, and then processing the data units through an LMM to generate a response to the query.

Method 500 starts at a step 505 and proceeds to a step 510. In step 510 input parameters, a query, and a long form input can be received. The input parameters can include a specified algorithm to use for determining data units to include, such as a down-sampling algorithm or a Top-K algorithm. The input parameters can specify various threshold parameters, such as a scoring threshold parameter, a quality threshold parameter, or other threshold parameters. The query can be a prompt used by the LMM to generate a response. The long form input (i.e., long input), can be one or more inputs, for example, videos, images, documents, or other long form inputs. Combinations of long inputs can be received.

In a step 515, a set of data units can be determined. A data unit is a segment or logic division of data from the long input. For example, a data unit for a video can be a frame of video, for a document, the data unit can be a page, slide, or other demarcation. In some aspects where a data unit is not indicated or defined in a document, a word count can be used, for example, every 250 or 300 words can define a page. In some aspects, data units can be grouped together to form a proposal or segment. For example, every two pages can be grouped together to form one data unit or every two images in a series of images can be grouped together. In some aspects, the grouping algorithm can use various counts or numbers of data units to group together (two is used as a demonstration here). In some aspects, the grouping algorithm can use a temporal proximity algorithm to determine a grouping of data units. In some aspects, the grouping algorithm can use a visual similarity algorithm to determine a grouping of data units. In some aspects, some data units can be tossed (e.g., removed) from consideration and selection. For example, a down-sampling algorithm can be applied to reduce the number of data units to be selected. In some aspects, a temporal proximity or visual similarity can be used to reduce frames of a video, assuming frames proximate or similar to each other are likely to repeat information.

In a step 520, the set of data units selected in step 515 can be scored against a likelihood or probability of contributing positively to generating a response to the query. In some aspects, the scoring process can use a probability value. In some aspects, the scoring process can use a binary choice. In a step 525, the scored data units can be selected into a second set of data units. In some aspects, data units with a score satisfying a score threshold parameter can be selected, for example, exceeding a probability percentage. In some aspects, data units that have a positive binary selection can be selected. In some aspects, the top n number of data units can be selected, for example, using a Top-K algorithm. In some aspects, a random sampling of the data units that meet a certain threshold can be selected. In some aspects, data units that tie at a threshold can each be selected or a random selection can be made.

In a step 530, the second set of data units can be processed through an LMM along with the query to generate an output representing a response to the query (e.g., the result). The data units can be formatted to satisfy the requirements of the LMM. In some aspects, the LMM can be a machine learning model. In some aspects, steps 515-525 can be part of the machine learning model. In a step 540, the result, representing the response to the query, can be generated. The result can be communicated to a user, for example, an online query. The result can be communicated to another system, for example, an autonomous vehicle decision process, a security system, or other types of systems. The result can be stored in a data store, for example, for use in training a machine learning system or an artificial intelligence system. Method 500 ends at a step 595.

FIG. 6 is an illustration of a block diagram of an example FRAG system 600. FRAG system 600 can be implemented in one or more computing systems or one or more processors. In some aspects, FRAG system 600 can be implemented using a FRAG controller such as FRAG controller 700 of FIG. 7. FRAG system 600 can implement one or more aspects of this disclosure, such as method 500 of FIG. 5.

FRAG system 600, or a portion thereof, can be implemented as an application, a code library, a dynamic link library, a function, a module, a header file, other software implementations, or combinations thereof. In some aspects, FRAG system 600 can be implemented in hardware, such as a ROM, a graphics processing unit, or other hardware implementation. In some aspects, FRAG system 600 can be implemented partially as a software application and partially as a hardware implementation. FRAG system 600 is a functional view of the disclosed processes, and an implementation can combine or separate the functions in one or more software or hardware systems.

FRAG system 600 includes a data transceiver 610, a FRAG processor 620, and a result transceiver 630. The output, e.g., the response to the query, can be communicated to a data receiver, such as one or more of a processing system 660 (one or more combinations of processors, or processing cores), one or more users or systems 662, or one or more storage devices 664. The output can be used to present a response to a user, stored for future use, or used as an input into other processing systems or machine learning systems.

In some aspects, the results of FRAG processor 620, such as those communicated to one or more processing systems 660, one or more storage devices 664, or one or more users or systems 662, can be used as input into another process or system, such as a machine learning system. The results can be used for further processing, such as for input into artificial intelligence learning, for validation of other system processes, or real-world applications, such as allowing a robotic system to make decisions, for example, autonomous driving, robotic assembly, or other automated decision points.

Data transceiver 610 can receive the input parameters, query, and long form input. The input parameters can be algorithms to use, such as the scoring algorithm to implement (e.g., Top-K, down-sampling, or other algorithms), various threshold parameters (e.g., a scoring threshold parameter, or other threshold parameters), and other operational parameters. The query can be a question, statement, or other type of input prompting for a response. The long form input can be one or more long inputs, e.g., a video, a series of images, a document, or various combinations thereof. In some aspects, data transceiver 610 can be part of FRAG processor 620.

Result transceiver 630 (e.g., a transmitter) can communicate one or more outputs (e.g., results), to one or more data receivers, such as processing systems 660, one or more users or systems 662, storage devices 664, or other related systems, whether proximate result transceiver 630 or distant from result transceiver 630. Data transceiver 610, FRAG processor 620, and result transceiver 630 can be, or can include, conventional interfaces configured for transmitting and receiving data. Data transceiver 610, FRAG processor 620, or result transceiver 630 can be implemented as software components, for example, a virtual processor environment, as hardware, for example, circuits of an integrated circuit, or combinations of software and hardware components and functionality. The functionality described for these components remains intact regardless of how the functionality is implemented.

FRAG processor 620 (e.g., one or more processors such as processor 730 of FIG. 7) can implement the analysis and algorithms as described herein, utilizing the input parameters. FRAG processor can execute code to implement a scoring system of data units, execute code to implement a LMM, or various combinations thereof. FRAG processor 620 can be one or more of a multicore processor, a multiprocessor system, or a streaming multiprocessor. FRAG processor 620 can be implemented by a central processor unit (CPU), a graphics processor unit (GPU), or other types of processors. FRAG processor 620 can be a non-transitory computer program product having a series of operating instructions stored on a non-transitory computer-readable medium that directs a video processing apparatus, when executed thereby to perform operations as disclosed herein.

A memory or data storage system of FRAG processor 620 (such as a core cache, L1 cache, L2 cache, or other memory systems) can be configured to store the processes and algorithms for directing the operation of FRAG processor 620. FRAG processor 620 can include a processor that can be configured to operate according to the analysis operations and algorithms disclosed herein, and an interface to communicate (transmit and receive) data.

FIG. 7 is an illustration of a block diagram of an example of a FRAG controller 700 according to the principles of the disclosure. FRAG controller 700 can be stored on one computer or multiple computers. The various components of FRAG controller 700 can communicate via wireless or wired conventional connections. A portion or a whole of FRAG controller 700 can be located at one or more locations. In some aspects, FRAG controller 700 can be part of another system (e.g., processor, core, server, or other systems), and can be integrated with one device, such as a part of a processing system. FRAG controller 700 represents a demonstration of the functionality employed for the disclosure, and implementations can use a variety of devices, for example, circuits of a processor, dedicated processors, virtual systems, servers, other computing or processing systems, be in software or hardware, or various combinations thereof.

FRAG controller 700 can be configured to perform the various functions disclosed herein including receiving input parameters, queries, and long form inputs, and generating results (e.g., query responses, statuses) from the execution of the methods and processes described herein, such as scoring data units of the long input and using a LMM to generate an output responding to the query. FRAG controller 700 includes a communications interface 710, a memory 720, and a processor 730.

Communications interface 710 can be configured to transmit and receive data. For example, communications interface 710 can receive the input parameters, the query, and the long form input. Communications interface 710 can transmit the output or interim outputs. In some aspects, communications interface 710 can transmit a status, such as a success or failure indicator of FRAG controller 700 regarding receiving the various inputs, transmitting the generated outputs, or producing the results.

In some aspects, processor 730 can perform the operations as described by FRAG processor 620. Communications interface 710 can communicate via communication systems used in the industry. For example, wireless or wired protocols can be used. Communication interface 710 can perform the operations as described for data transceiver 610 and result transceiver 630 of FIG. 6.

Memory 720 can be configured to store a series of operating instructions that direct the operation of processor 730 when initiated, including supporting code representing the algorithm for selecting data units, scoring data units, and processing the data units through an LMM. Memory 720 can be a non-transitory computer-readable medium. Multiple types of memory can be used for the data storage systems, and memory 720 can be distributed.

Processor 730 can be one or more processors. Processor 730 can be a combination of processor types, such as a CPU, a GPU, a single instruction multiple data (SIMD) processor, or other processor types. Processor 730 can be configured to produce the output, one or more interim outputs, and statuses utilizing the received inputs. Processor 730 can determine the output using parallel processing (e.g., using a parallel processing system). Processor 730 can be an integrated circuit. In some aspects, processor 730, communications interface 710, memory 720, or various combinations thereof, can be an integrated circuit. Processor 730 can be configured to direct the operation of FRAG controller 700. Processor 730 includes the logic to communicate with communications interface 710 and memory 720, and perform the functions described herein. Processor 730 can be capable of performing or directing the operations as described by FRAG processor 620 of FIG. 6.

For example, in some aspects, FRAG system 600 or FRAG controller 700 can perform selecting data units to score, scoring the selected data units, subsequently selecting data units to process, and processing the data units through an LMM. In some aspects, FRAG system 600 or FRAG controller 700 can be part of another system that receives the input parameters, query, and long form input. For example, in some aspects, FRAG system 600 or FRAG controller 700 can be part of a machine learning system, an AI generative tool, or can be in a data center, a cloud system, an edge system, a corporate system, or other types of systems or locations. In some aspects, FRAG system 600 or FRAG controller 700 can be part of a machine learning system, where FRAG processor 620 can be part of the machine learning processes. In some aspects, FRAG system 600 or FRAG controller 700 can implement a non-transitory computer program product having a series of operating instructions stored on a non-transitory computer-readable medium that directs a data processing apparatus when executed thereby to perform operations, the operations comprising the steps described herein for this disclosure, such as method 500 of FIG. 5. In some aspects, FRAG system 600 or FRAG controller 700 can implement a non-transitory computer-readable medium having a series of operating instructions that directs a data processing apparatus when executed thereby to perform the operations.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the necessary logic or features for performing a task or tasks. The processors or computers can be part of GPU racks located in a data center. The GPU racks can be high-density (HD) GPU racks that include high-performance GPU compute nodes and storage nodes. The high performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for AI computing and GPU data centers directed to AI computing. The HD GPU racks can be used with reactive machines, autonomous machines, self-aware machines, and self-learning machines that may need a massive compute compute-intensive server infrastructure. For example, the GPU data centers employing HD GPU racks can provide the storage and networking needed to support large-scale neural network (NN) training, such as for the NNs disclosed herein used for neural motion planners. The NNs can be Deep Neural Networks (DNN).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as noted above are capable of delivering the performance required for training NNs for artificial intelligence and machine learning applications.

Portions of disclosed examples or embodiments can relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein. Additional material is also submitted herewith.

Each one of the aspects disclosed in the Summary can include a combination of one or more of the features of the following dependent claims.

What is claimed is:

1. A query system, comprising:
a long input scorer configured to score scoring data units of a long input, wherein the scoring data units are frames when the long input is a video or a series of images, or the scoring data units are pages when the long input is a document; and
a large multimodal model (LMM) configured to select a set of data units from the scoring data units where each data unit in the set of data units satisfies a score threshold parameter, and to process the set of data units, using a received query, to generate a result to the received query.

2. The query system as recited in claim 1, further comprising:
a receiver configured to receive the long input and the received query,
wherein the received query asks a question related to the long input.

3. The query system as recited in claim 1, wherein the LMM and the long input scorer are part of a machine learning model.

4. The query system as recited in claim 1, wherein the score threshold parameter can be a Top-K parameter indicating a number of scoring data units with a highest score.

5. The query system as recited in claim 1, wherein the long input scorer is further configured to perform zero-shot scoring.

6. The query system as recited in claim 1, wherein the LLM is further configured to perform zero-shot processing of the set of data units.

7. The query system as recited in claim 1, wherein the long input scorer utilizes a sufficiency threshold to score the scoring data units.

8. The query system as recited in claim 7, wherein the sufficiency threshold uses a probability of a type of response.

9. The query system as recited in claim 7, wherein the long input scorer utilizes a binary scoring algorithm.

10. The query system as recited in claim 1, wherein the long input scorer utilizes a parallel processing system and the scoring data units are processed independently of each other.

11. The query system as recited in claim 1, wherein original data units of the long input are down-sampled to generate the scoring data units.

12. The query system as recited in claim 1, wherein at least some of each scoring data unit in the scoring data units is more than one frame or more than one page.

13. The query system as recited in claim 1, wherein selection of the set of data units utilizes temporal proximity or visual similarity to select each data unit.

14. The query system as recited in claim 1, wherein the result is text-based.

15. A method comprising:
receiving input parameters, a query, and at least one long input, wherein the query is to be associated with the at least one long input;
determining a set of scoring data units, wherein the set of scoring units is selected from original data units of the at least one long input;
scoring each data unit in the set of scoring data units using the input parameters;
selecting a second set of data units from the set of scoring data units that satisfy a scoring threshold parameter using the input parameters and the query;
processing the second set of data units and the query using a large multimodal model (LMM); and
generating a result to the query using an output of the LMM.

16. The method as recited in claim 15, wherein the determining a set of scoring data units utilizes a computational cost for each data unit in the set of scoring data units.

17. The method as recited in claim 15, wherein the scoring processes each data unit in the set of scoring data units at least partially in parallel.

18. The method as recited in claim 15, wherein the at least one long input is a video, a series of images, or a document.

19. A system, comprising:
a receiver system configured to receive a query, a long form input, and input parameters;
a scoring system configured to determine a set of data units to score from data units included with the long form input, to score the set of data units, and to select a second set of data units from the set of data units when a respective score of each data unit satisfies a score threshold parameter; and
one or more processors, configured to execute code representing a large multimodal model (LMM) and to process the second set of data units and the query to generate an output.

20. The system as recited in claim 19, wherein the long form input is a surveillance video, a streaming video, or a driving video.

21. The system as recited in claim 19, wherein the long form input is a slide deck, a presentation, a PDF document, or a text-based document.

22. The system as recited in claim 19, wherein the scoring system is a second set of one or more processors and the score the set of data units is performed at least partially in parallel.

23. The system as recited in claim 19, wherein the one or more processors is a machine learning system.

24. The system as recited in claim 23, wherein the machine learning system includes the scoring system.

25. The system as recited in claim 19, wherein the one or more processors is one or more of a central processor unit (CPU) or a graphics processor unit (GPU).

26. A non-transitory computer program product having a series of operating instructions stored on a non-transitory computer-readable medium that directs a data processing apparatus when executed thereby to perform operations, the operations comprising:
receiving input parameters, a query, and at least one long input, wherein the query is to be associated with the at least one long input;
determining a set of scoring data units, wherein the set of scoring units is selected from original data units of the at least one long input;
scoring each data unit in the set of scoring data units using the input parameters;
selecting a second set of data units from the set of scoring data units that satisfy a scoring threshold parameter using the input parameters and the query;
processing the second set of data units and the query using a large multimodal model (LMM); and
generating a result to the query using the output of the LMM.

27. The non-transitory computer program product as recited in claim 26, wherein the operations are executed using a machine learning system.
